(19) United States
(12) Patent Application Publication
(10) Pub. No.: US 2004/0229562 A1
(43) Pub. Date: Nov. 18, 2004

(54) Method and apparatus for ODU to IDU telemetry interface and VSAT systems

(75) Inventors: Christopher Wren, Carlsbad, CA (US); Darryn W. Prince, Encinitas, CA (US); Mark J. Miller, Encinitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ViaSat, Inc. (a Delaware corporation), Carlsbad, CA

(21) Appl. No.: 10/837,298

(22) Filed: Apr. 30, 2004

Related U.S. Application Data
(60) Provisional application No. 60/471,110, filed on May 16, 2003.

(51) Int. Cl. H04H 1/00

(52) U.S. Cl. 455/3.02; 455/3.01

(57) ABSTRACT

A single cable inter-facility link is provided using an IDU-ODU telemetry interface employing an encoder in the status transmit circuitry and in the control transmit circuitry which encodes the appropriate data by integrating Manchester encoding, a preamble and postamble, and on-off keying to create a unique data packet scheme which is compatible with any existing inter-facility link protocol and which does not interfere with the DC power or normal data traffic. Together with a simple receiver structure implementing an adaptive threshold detector that decodes the telemetry data, any kind of information can be communicated between the IDU and ODU over a single cable. Control of the ODU by the IDU via a bi-directional half-duplex or full-duplex telemetry interface allows the IDU to control the ODU settings.

### CROSS-REFERENCES TO RELATED APPLICATIONS

The present application claims benefit of the filing date of U.S. provisional application No. 60/471,110 filed on May 16, 2003, the entire content of which is incorporated herein by reference.

### STATEMENT AS TO RIGHTS TO INVENTIONS MADE UNDER FEDERALLY SPONSORED RESEARCH OR DEVELOPMENT

Not Applicable

REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

This invention relates to VSAT (Very Small Aperture Terminal) telecommunication systems and in particular to the architecture of the receiving and detecting functions for the antenna and receiver for receiving signals from a satellite.

For many modem communication terminals, the system architecture consists of an Outdoor Unit (ODU) and an Indoor Unit (IDU). The ODU typically performs the front-end radio and antenna functions exposed to the environment, and it provides an interface to the IDU. It is designed to withstand the more severe environmental outdoor conditions. The IDU typically performs the modem and networking functions and interfaces to the user and customer premise equipment. The IDU is physically located in more benign operating conditions than the ODU. The inter-facility link, namely, the physical connection between the IDU and ODU, may vary, depending on the functional partitioning between the two subsystems. However, it is not uncommon for the inter-facility link to consist of a single coaxial cable. Transmit and receive signals as well as a frequency reference signal (typically 10 MHz) are conventionally multiplexed on the same cable, along with a DC supply voltage needed to power the ODU. However, ODU to IDU control communication that is designed to be communicated through baseband techniques can only be effected on a second cable or cable set. This significantly increases the complexity and cost of a set of units.

As data rates continue to increase and unit costs continue to decrease it becomes increasingly necessary to have some sort of communication link between the IDU and the ODU. By allowing the IDU to monitor data such as the ODU transmit power, as well as other status information the IDU can make adjustments to compensate for the ODU's performance, thus relaxing the requirements for the ODU performance and lowering the cost of the ODU.

It is desired that the ODU to IDU communication be effected on the same cable as other signals, thus greatly simplifying and reducing the cost of the inter-facility link (IFL). However integrating these five elements on a single cable has proven to be a longstanding problem, and no simple, cost-effective method for doing this exists although many attempts have been made. Communicating across the IFL through baseband techniques offers the simplest approach and most affordable hardware. However, conventional baseband IDU/ODU communication techniques cannot be used when a DC voltage is present on the cable, so a second cable has been required to implement this method. Known methods of transmitting the IDU-ODU data that avoid this problem include common analog and digital modulation techniques. These approaches have drawbacks because analog modulation, such as AM or FM, requires calibration to obtain and maintain proper performance over temperature variations and long-term component aging. Digital modulation techniques, such as BPSK can produce good performance without calibration, but they generally require a complex implementation with automatic gain control (AGC) and timing recovery.

Another technique for IDU/ODU communication is known as the Digital Satellite Equipment Control Bus (DiSEqC) standard, a published standard developed by EUTELSAT. Under this bus standard, communication on the inter-facility link is achieved with a pulse width keyed data bit symbol of 1.5 ms duration with the pulse tone at 22 kHz. One problem with this system is its relatively low data rate (limited to 667 bps). The system is quite complex due to the needed bus structure (designed so that several ODUs can be connected to a single IDU), not to mention the complexity of the pulse width keying demodulator.

What is therefore needed is a simpler, more cost-effective, easy to implement and easy to mass-produce method for producing high data rate IDU/ODU communication via a single inter-facility link which can coexist with normal data transmit and data receive traffic, the reference signal, and the ODU DC supply voltage.

### SUMMARY OF THE INVENTION

According to the invention, a single cable inter-facility link is provided using an IDU-ODU telemetry interface employing an encoder in the status transmit circuitry and in the control transmit circuitry which encodes the appropriate data by integrating Manchester encoding, a preamble and postamble, and on-off keying to create a unique data packet scheme which is compatible with any existing inter-facility link protocol and which does not interfere with the DC power or normal data traffic. Together with a simple receiver structure implementing an adaptive threshold detector that decodes the telemetry data, any kind of information can be communicated between the IDU and ODU over a single cable. The main utility of the ODU-IDU telemetry interface is to allow the IDU to monitor the output power of the ODU as well as other “status” information. Control of the ODU by the IDU via a bi-directional half-duplex or full-duplex telemetry interface according to the invention allows the IDU to control the ODU settings, such as transmit and receive frequency control words, transmit enable/disable (on/off) switch, transmit attenuation settings, and receive IF gain adjustment settings. The invention defines a telemetry interface that provides this functionality as a subset of the overall architecture leading to a low cost solution for ODU control by the IDU.

The ODU to IDU telemetry interface includes and merely requires relatively simple encoding and decoding hardware to implement. The telemetry interface according to the invention achieves the desirable qualities of digital modulation (high data rates and good performance over time and temperature) for an inter-facility link without the complexity previously required in a digital implementation. It thus allows the implementation of both a continuous transmission system and a flexible burst transmission system with timing synchronization between the ODU and ODU, as well as fast settling frequency-hopped transmission, slow frequency hopped transmission and fixed frequency transmission.

These are some of the advantages of this invention.

1. By providing that the IDU constantly monitor and control the output power of the ODU, requirements for ODU gain variation; gain flatness, temperature compensation, absolute output accuracy, inter-facility link cable variations over frequency; IDU analog output gain variations, ripple, VSWR ripple, attenuator step size, attenuator accuracies can all be relaxed, thus allowing for more affordable parts to be used in the construction of the hardware. It also allows more flexibility in installations. Since the IDU will automatically compensate for any attenuation that occurs in the inter-facility link, a larger range of inter-facility lengths is allowed.

2. Monitoring other status information from the ODU greatly enhances the service provided. This allows the IDU to notify the service provider of necessary preventative maintenance and to automatically schedule service. This includes scenarios where a graceful degradation has occurred, where the terminal is still providing acceptable service performance but has reached a point of degradation where the performance is not at the specification limits. Equipping the IDU with a simple mechanism that monitors OPldB allows it to determine whether the ODU transceiver or boost amplifier needs to be field replaced or undergo preventative maintenance. Solid state power amplifier end of life degradation and fan failures which characteristically have been shown to have an effect on MTBF's are monitored. Unit-by-unit automatic monitoring and reporting also enhances the service offering, allowing automatic notification to the service provider of any replacements or repairs that need to be made. Thus, overall system reliability achievable through better preventative maintenance is a benefit realized by the end user.

3. Unwanted transmissions are also minimized. Fault detection and fault isolation of the ODU by the IDU is also possible over the telemetry link. Regulatory agencies require that a transmitter be disabled when a transmission fault is detected. The ODU monitors local faults and reports these to the IDU. The IDU then automatically turns off the transmit circuitry in the event that a fault is detected.

4. Multiplexed signal interface reduces inter-facility link cabling requirements and interconnect resulting in a simpler and lower cost terminal when installed and operated over multiple cable interfaces. This invention also takes advantage of low cost cabling performance by staying at frequencies easily transmitted over low cost cable.

5. Telemetry digital modulation and demodulation design simplifies hardware and lowers parts cost by allowing for use of readily available analog components. Because the ODU transmitter uses Manchester encoding, no precision or calibrated parts are required for demodulation and decoding in the IDU. Thus the encoding, decoding, modulation and demodulation can be implemented with a small parts count using readily available low cost parts.

6. Scalable design is easily modified to provide for supporting data links at a variety of rates. Demodulation and data synchronization do not need to be modified for different size packets and data rates.

This invention will be better understood by reference to the following detailed description in connection with the accompanying drawings.

### BRIEF DESCRIPTION OF THE DRAWINGS

FIG. 1 is a the top level block diagram showing an IDU and ODU connected by a single Inter Facility Link (IFL).

FIG. 2 is a high level circuit diagram of an ODU in accordance with the invention.

FIG. 3 is a high level circuit diagram of an example of status transmit circuitry in accordance with the invention.

FIG. 4 is a diagram of one embodiment of telemetry logic used in accordance with the invention to generate packets of data that will be sent to the IDU.

FIG. 5 is a diagram of one embodiment of a Control Receive Circuitry in accordance with the invention.

FIG. 6 is a high level block diagram of one embodiment of an IDU Circuit in accordance with the invention.

FIG. 7 is a diagram of one embodiment of a Status Receive Circuit according to the invention.

FIG. 8 is a diagram of one embodiment of a control transmit circuit in accordance with the invention.

FIG. 9 is a diagram illustrating one possible way to define telemetry messages sent over the IFL.

FIGS. 10A, B and C are illustrations of how in the frequency domain this invention (methods A and B) differ from the prior art EUTELSAT method.

FIG. 11 illustrates a definition of Manchester Encoding as well as how sample packets are defined in the present invention.

FIG. 12 is a timing diagram illustrating how the envelope detector and comparator in the IDU serve to demodulate the data received from the ODU in accordance with the invention.

FIG. 13 is a timing diagram for examples of the telemetry logic and demonstrating how packets are created.

FIG. 14 is a diagram illustrating a way to organize packets so that a bi-directional telemetry link can be established between the IDU and ODU.

### DETAILED DESCRIPTION OF THE INVENTION

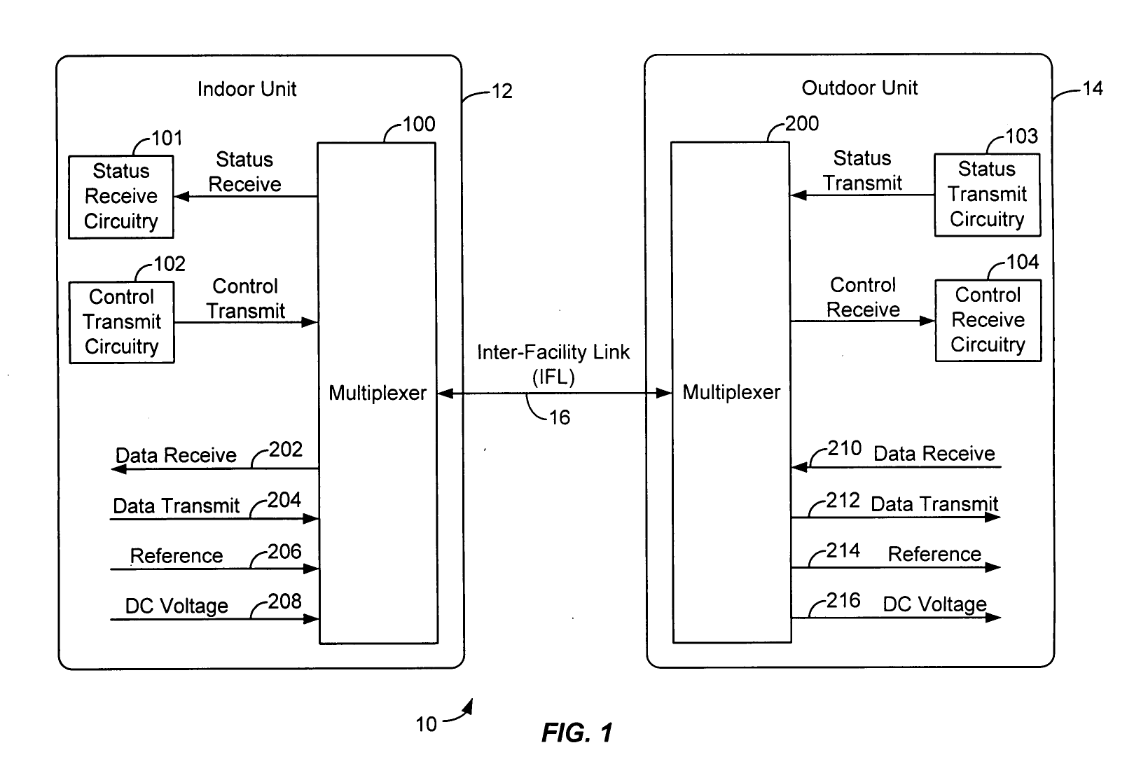

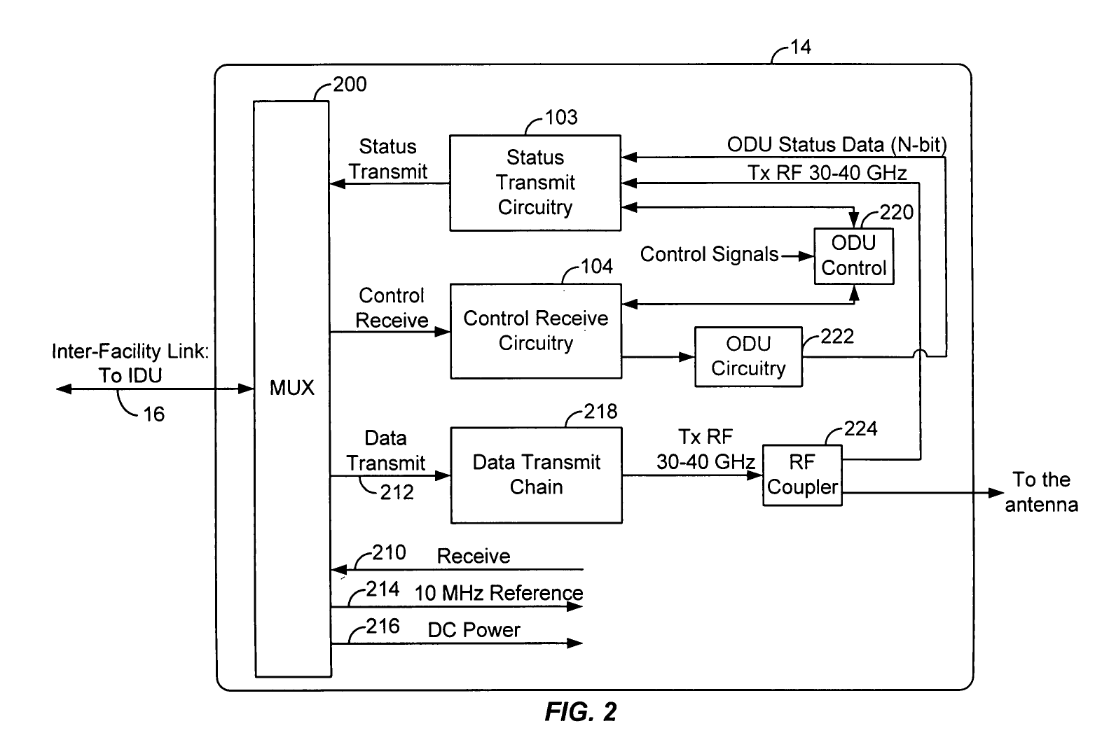

FIG. 1 shows the top level layout of a satellite ground station transceiver control circuit 10 with an IDU 12 and an ODU 14 connected by a telemetry interface using a single physical Inter Facility Link (IFL) 16 operative according to a telemetry interface protocol as herein explained and referred to herein as a telemetry interface. The IFL 16 carries Status Telemetry, Control Telemetry, Data Transmit, Data Receive, Reference Signal and DC Voltage. The IDU 12 has an IDU multiplexer 100 coupled to status receive circuitry 101 and control transmit circuitry 102. The IDU multiplexer 100 also provides data receive 202 to the ground station, handles data transmit 204 from the ground station, a reference signal 206 from the ground station, and DC voltage 108. The ODU 14 has an ODU multiplexer 200 that is coupled to status transmit circuitry 103 and to control receive circuitry 104. The ODU multiplexer 200 also handles data receive 210 from the satellite (not shown), data transmit 212 to the satellite, a reference signal 214 and DC voltage 216. These features are shown in greater detail in FIG. 2. According to the invention, the telemetry interface minimizes required circuitry in the ODU 14 without over-complicating the receiver of the IDU 12. The telemetry interface utilizes a “digital” amplitude modulation scheme that may be at any frequency that does not interfere with other information on the IFL 16, (for example, an 85 MHz carrier for an L-band IFL). In operation a digital symbol “1” is transmitted over the IFL 16 by enabling a tone and a digital symbol “0” is achieved through nulling the tone. Any type of information can be sent over the telemetry interface, i.e., according to the telemetry interface protocol. However, there are two major categories that are mainly used, as described herein.

FIG. 2 shows the circuitry of a typical ODU 14 in accordance with the invention. It has Status Transmit Circuitry 103 having the function to measure RF output power and convert this data as well as other status information into packets that can be sent over the IFL 16 to the IDU 12. The ODU 14 also has Control Receive Circuitry 104 having the function to receive packets from the IDU 12, to decode the packets into the constituent commands, and to pass this information to the appropriate circuitry of ODU 14. Further it has multiplexer 200 having the function to combine all signals onto a form that can be carried on the IFL 16. Still further it has a Data Transmit Chain 218 coupled to receive the data transmit signals 212 and having the function to frequency shift those signals to be transmitted from the intermediate frequency (IF) to the higher transmitted radio frequency (RF). Still further it has an ODU control module 220 coupled between the Status Transmit Circuitry 103 and the Control Receive Circuitry 104. Its use is only under operational Method B to schedule packet send and packet receive of the control and status telemetry in order to avoid packet collision. The ODU 14 has what is herein labeled ODU Circuitry 222 having the function of reading and responding to incoming Control Commands from the Control Receive Circuitry 104 and to pass on to the Status Transmit Circuitry 103 selected extracted status information to be transmitted to the IDU 14 (FIG. 1). An RF coupler 224 coupled to receive the RF signals from the Data Transmit chain 218 is coupled to an antenna (not shown) and to the Status Transmit Circuitry 103 to relay the transmitted RF signal to both the antenna and the Status Transmit Circuitry 103.

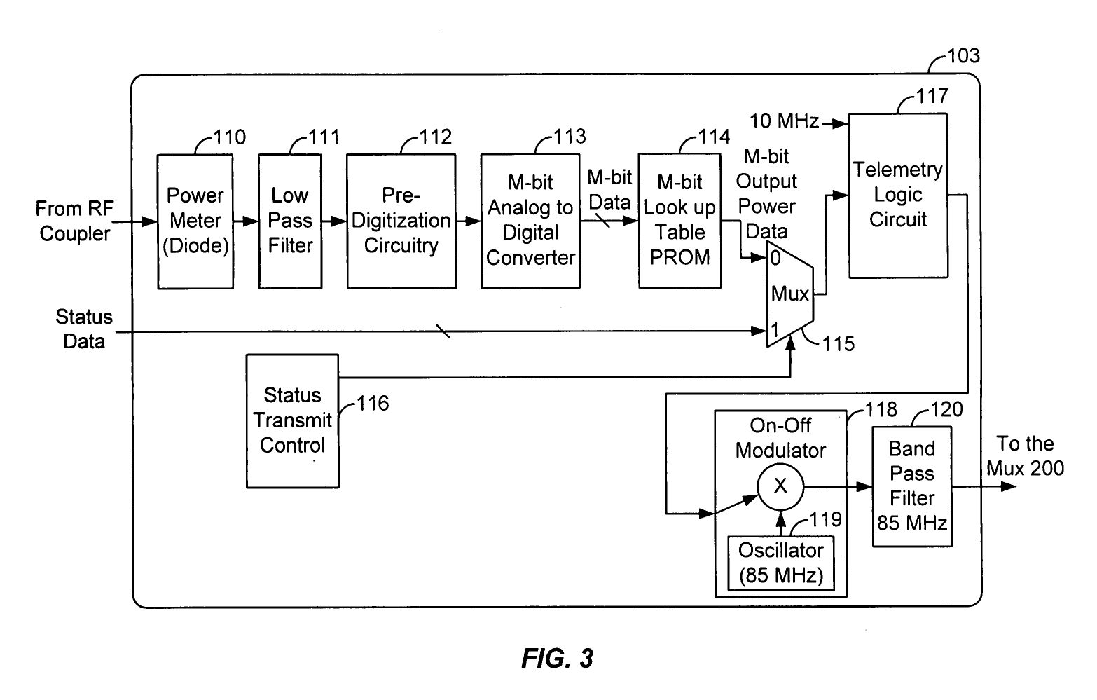

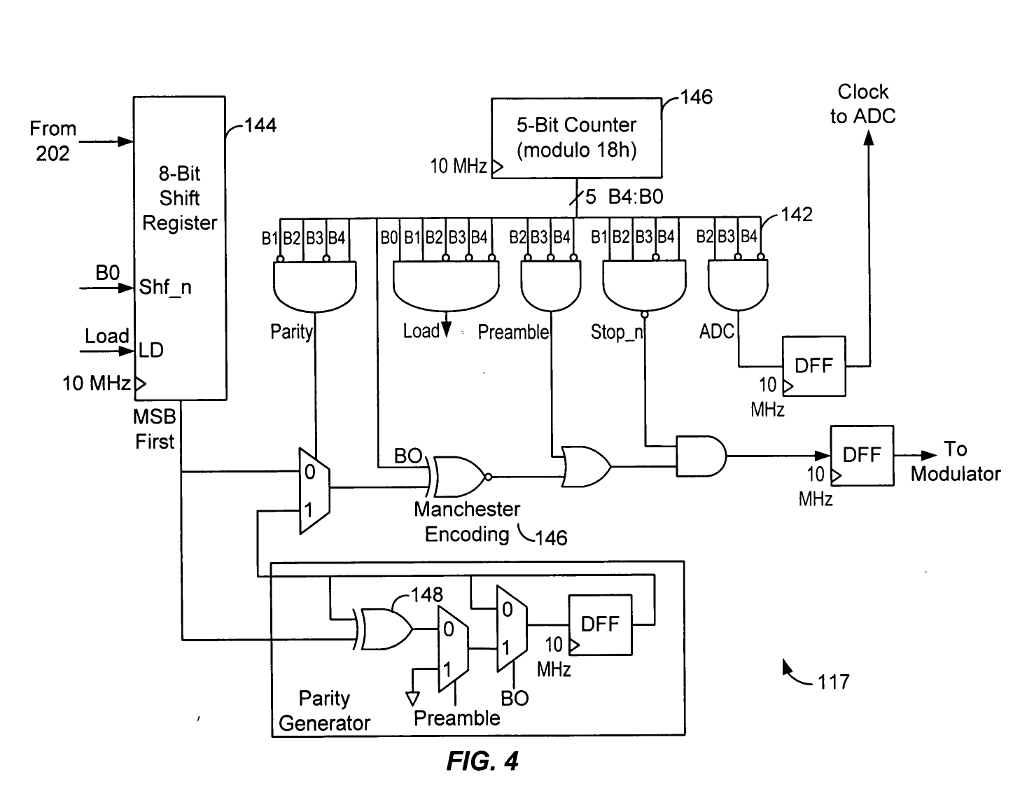

FIG. 3 shows an example of Status Transmit Circuitry 103 in accordance with the invention. A diode detector 110 is coupled to receive RF and DC from the RF coupler 224 (FIG. 2) and measures the DC level of ODU output power. It feeds its output to a low pass filter 111 operative to minimize out of band noise in the DC measurements. The output is coupled to pre-digitization circuitry 112, which is operative to adjust the output power voltage to match the input signal interface specifications of an M-bit analog to digital converter ADC 113 to which its signal is coupled. The output of the ADC 113 is coupled to an M-bit look-up table in a PROM or the like 114, which is used for converting a voltage reading to the digital domain representing output power. The digital output is provided as parallel bit lines to a multiplexer 115 that is operative under the supervision of a status transmit control circuit 116, which determines whether output power or other status data (input to the Status Control Circuitry 103 from elsewhere will be transmitted to the IDU 12 (FIG. 1). The N-bit status data is typically padded with lead zeros to match the format of the M-bit output power data. The multiplexer 115 feeds digital M-bit data to a telemetry logic circuit 117 (FIG. 4), which formats the digital data into packets. Its output packets are supplied to an on/off modulator 118, which employs a local oscillator 119 of for example 85 MHz to convert the digital data packets into frequency pulses. The output is fed through a bandpass filter 120 to suppress spurious artifacts before being fed to the ODU multiplexer 200 (FIG. 2).

The first type of data sent to the IDU 12 by the ODU 14 over the telemetry interface, i.e, according to the telemetry interface protocol via the IFL 16, is output power. A simple diode detector 110 in the ODU 14 can be used to measure the output power in accordance with typical industrial practice. As shown in FIG. 2, the RF coupler 224 provides the signal to be transmitted to both the antenna (not shown) and to the diode detector 110 (FIG. 3) with good matching and minimum loss. The diode detector 110 converts the RF power to an analog voltage as detected from the output from the coupler. The diode detector 110 output is low pass filtered in order to remove the higher order undesired products. The low pass filter 111 is designed so that the reading is capable of settling in time to adequately provide a valid output value representative of the output power level in real time. The filter design is especially important for frequency hopped and burst transmission systems. The filtered output signal is then conditioned such that the interface to the M-bit ADC 113 is within the input signal interface specifications of the ADC 113. The circuitry required to do this may be as simple as a resistor divider network, or it may include operational amplifiers in order to provide a DC bias offset and signal level scaling. The filtered voltage is then sampled using the M-bit ADC 113. The M-bit data is then passed through the lookup table PROM 114. The M-bit ADC digital word is an address value that addresses a PROM table for the representative data value. The PROM 114 is used to minimize measurement errors such as coupler offset errors and errors due to temperature changes as well as distinguish the data as an output power reading. The PROM 114 is calibrated to convert the M-bit data into N-bit data, where N is greater or equal to M. The N-bit data will represent the output power of the ODU as well as define the data as a power reading, distinguishing it from other types of data.

The second type of data sent over the telemetry interface is status information. Status information can be inserted at any time into the data stream of the telemetry interface. The IDU 12 distinguishes status information from output power information by its N-bit value. A few N-bit values are reserved to represent different status information messages.

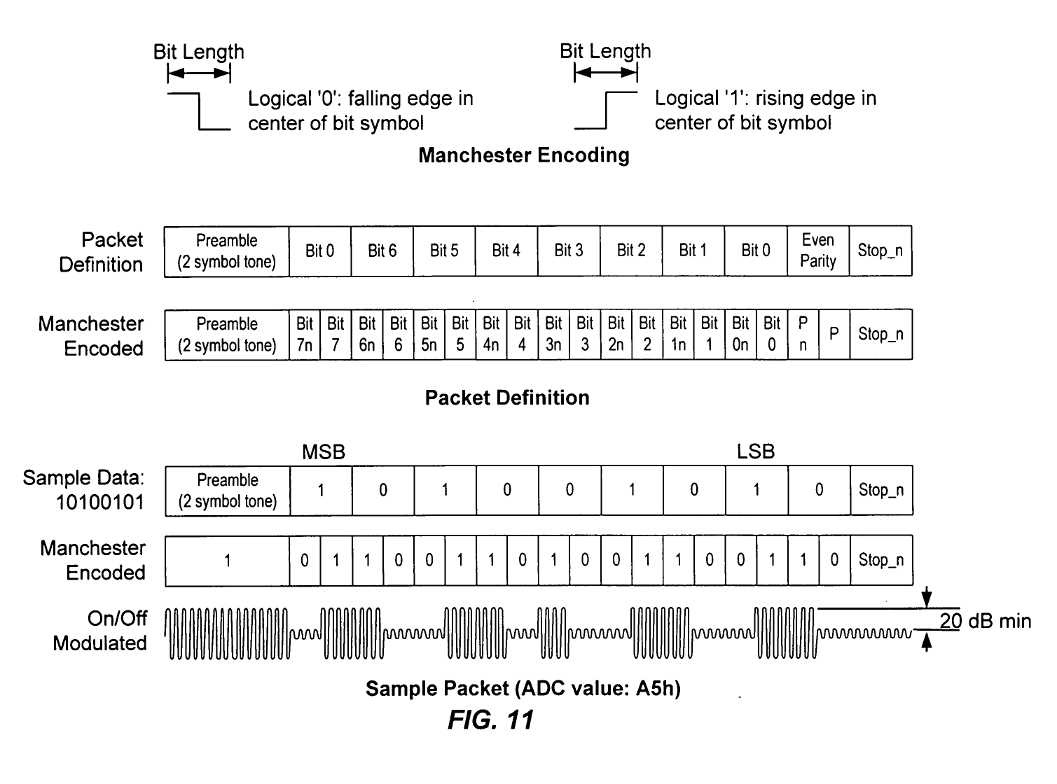

The N-bit data is processed through the telemetry logic circuit 117 (FIG. 4 for details) to create data packets 126 (FIG. 11) that can be modulated and transmitted across the IFL 16 via the MUX 200. In the telemetry logic circuit 16, the N-bit data (either output power or status) is encapsulated with a 2-symbol preamble 130 and a 1-symbol postamble 132 (see FIG. 11). The IDU 12 utilizes the preamble/postamble to detect word synchronization. The preamble 130 is a digital “1” (or 2-symbol duration tone) while the postamble 132 is a digital “0” (or 1-symbol duration null). N-bit words are Manchester encoded (as shown in FIG. 11) to differentiate data from the preamble/postamble, as well as to improve synchronization between the IDU 12 and ODU 14. Manchester encoding guarantees a bit transition at the center of each data symbol. A digital “1” bit is represented with a rising edge transition and a digital “0” bit is represented with a falling edge transition (see FIG. 11).

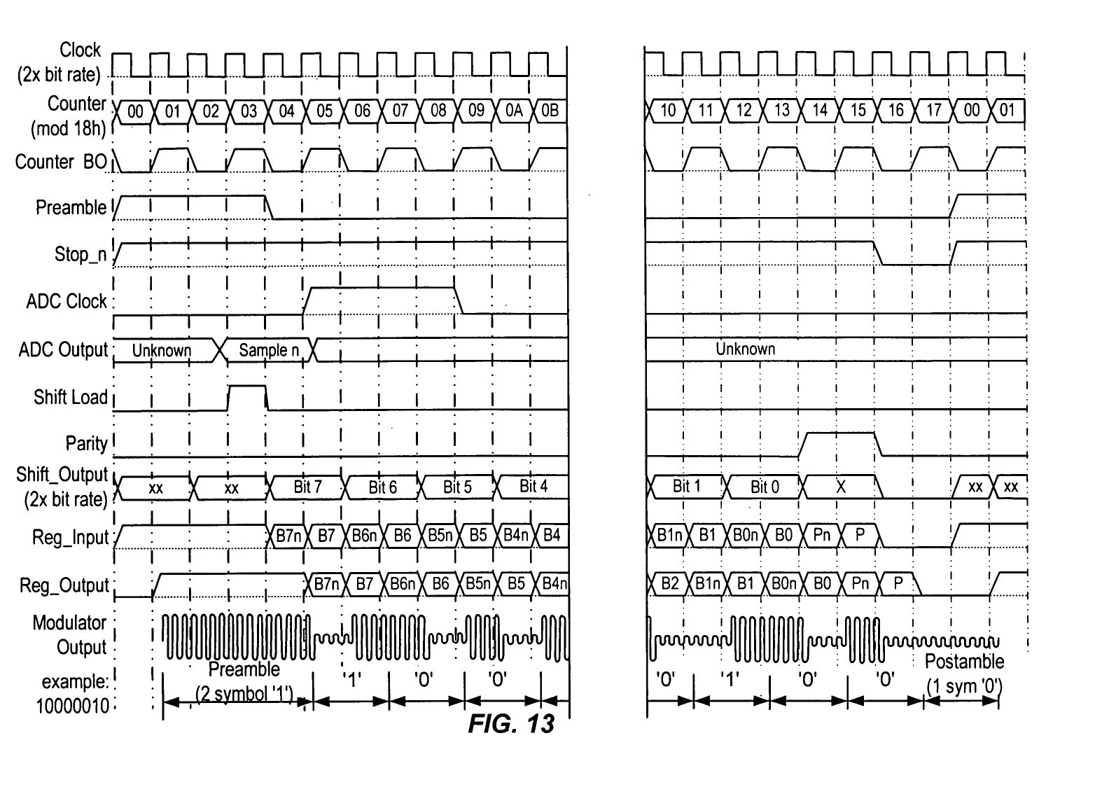

This example circuit 117 operates using a 10 MHz clock. The telemetry logic utilizes a 5-bit modulo 18h counter 140 for timing control. Data alignment/control is provided by simple decode logic of the 5-bit counter output. Shown in the circuit 117 is an 8-bit ADC 142 followed by an 8-bit parallel to serial 8-bit register 144. Manchester encoding (an XNOR gate 146), and parity generation (XOR gate 148) are also provided. The exact control circuitry for the ADC interface (ADC Clock and 8-bit shift register controls) will vary depending on the specific ADC selected. The circuit 117 in FIG. 4 assumes an 8-bit parallel ADC that takes approximately 2.2/sec (22 10 MHz clock cycles). See FIG. 13 for a complete example of a timing diagram for the ODU 14. (In an embodiment where the ADC has an internal output register, then a more appropriate circuit (i.e., one having fewer gates) could utilize an 8:1 multiplexer (of approximately 21 gates) instead of the illustrated 8-bit serial shift register (of approximately 64 gates) as well as utilize combinational logic for parity generation, i.e., eliminating the need for DFFs.)

The data packets of the example system are then passed through the On-Off Modulator 118 (FIG. 3) that uses an 85 MHz carrier (which may be of any frequency that does not interfere with other information on the inter-facility link 16 and yet stays within L-band bandwidth limitations). This On-Off keying creates a form of “digital” amplitude modulation. A digital symbol “1” is achieved by enabling a tone and a digital symbol “0” is achieved through muting the tone to form a tone-modulated data packet. The tone-modulated data packet is then passed through the band pass filter 120 centered at the carrier of 85 MHz to reduce spurs and increase efficiency before being passed to the MUX 200.

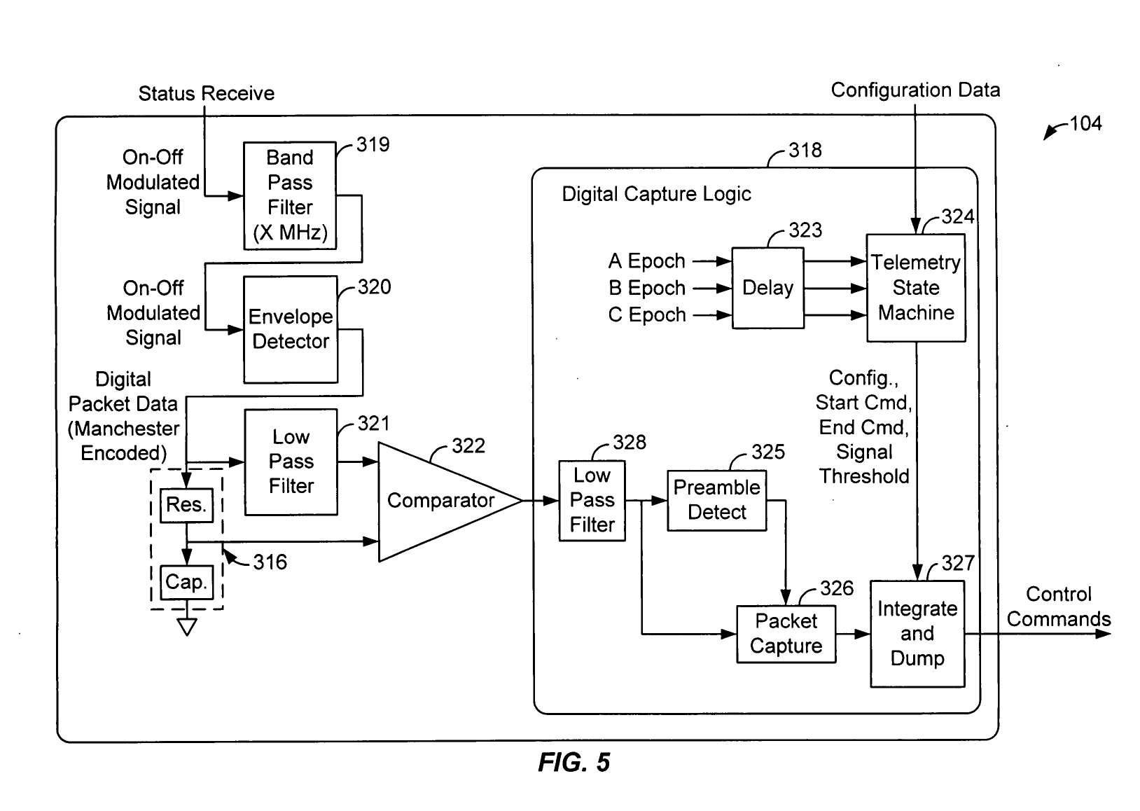

Referring to FIG. 5, Control Receive Circuitry 104 in accordance with the invention is in the ODU 14. Its principal function is in its digital capture logic 318. It employs preprocessing as follows: An X MHz bandpass filter 319 centered at the control transmission frequency to eliminate noise from the IFL 16 is coupled to an envelope detector 320 to convert the pulse modulated signal to a digital signal, which in turn is coupled to a lowpass filter 321 to eliminate high frequency noise from the signal, and which in turn is coupled to a comparator 322 to distinguish between on and off levels and to normalize the signal to match the input requirements of digital capture logic 318. There is provided a threshold detection circuit 316 which in a specific embodiment is an automatically calibrated threshold unit at the input to the comparator 322 to track the Manchester encoded input. In a specific embodiment, it is a long time-constant RC circuit referenced to ground. The example digital capture logic utilizes the following: a delay 323, a Telemetry state machine 24, a preamble detector 325, a packet capture module 326, and an “integrate and dump” module 327. The output of the comparator 322 is fed through a digital lowpass filter 328 to the preamble detector 325 and the packet capture module 326, which uses the preamble detector output for synchronization to provide signal to the integrate and dump module 327, the output of which are control commands that are clocked out by the telemetry state machine 325 in accordance with input configuration data and the appropriately delayed epoch information. The digital lowpass filter 328 includes an analog to digital filter and counter, which outputs a true or false (a one or a zero) representative of a simple majority vote over a period of odd-numbered samples, for example five samples, in a half clock cycle. The preamble detector 325 thus simply reads the digital values produced by the digital lowpass filter 328.

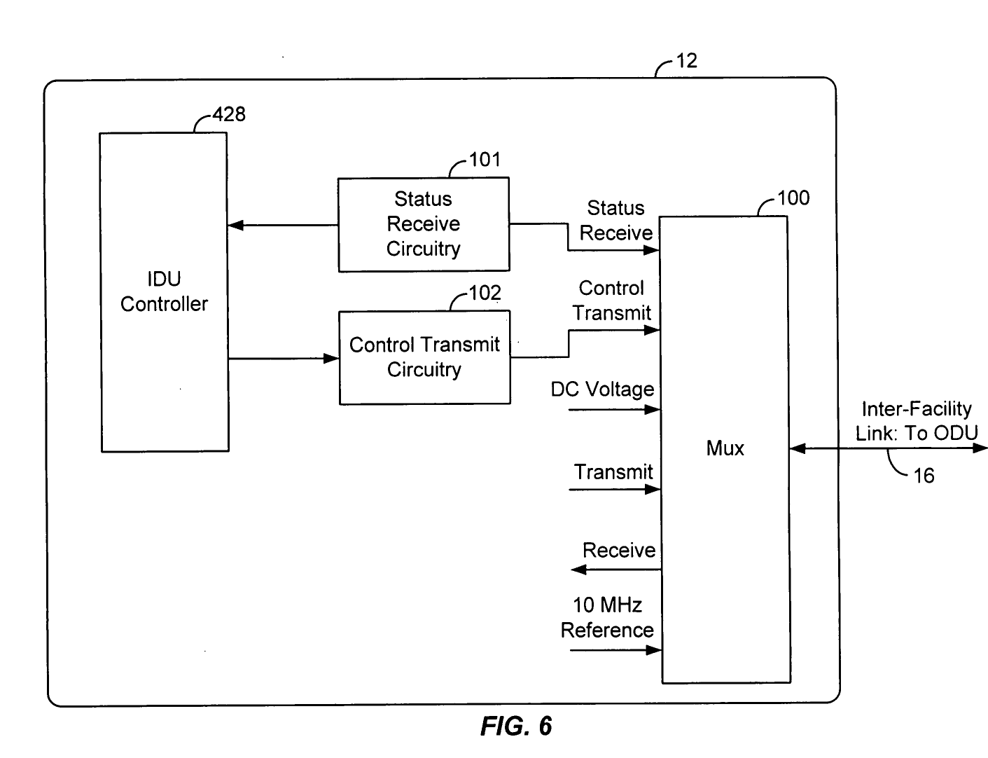

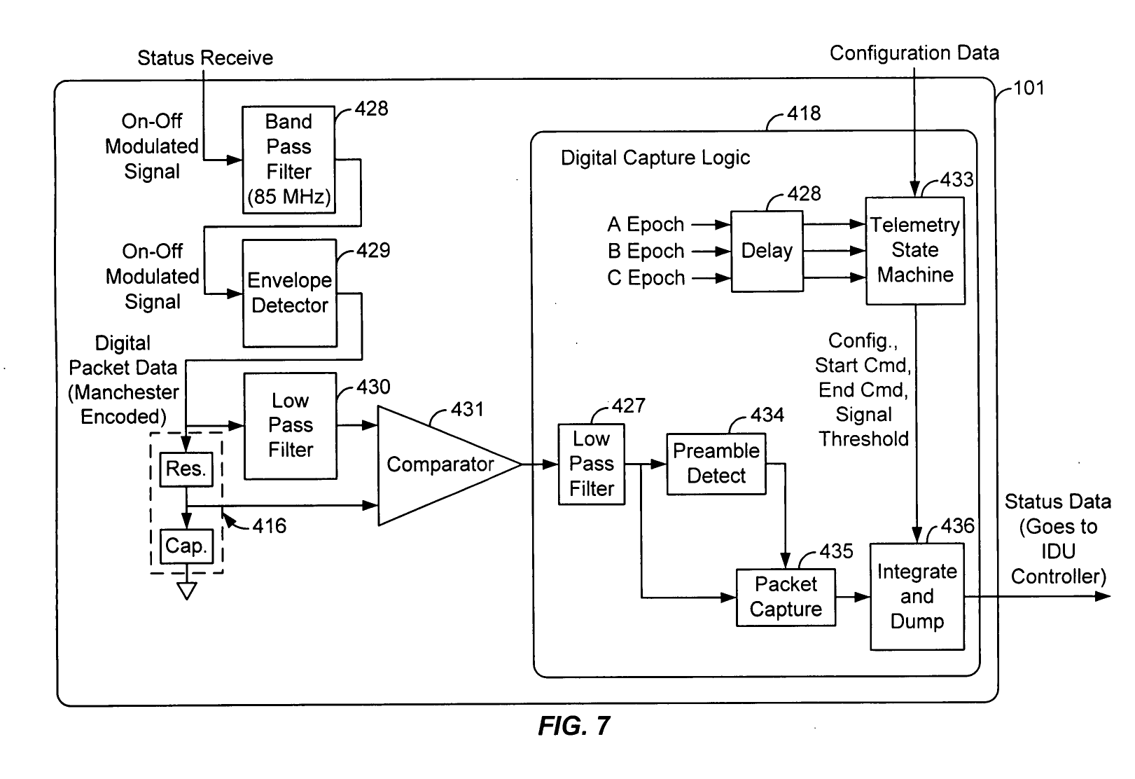

Referring to FIG. 6 and to expand on FIG. 1, the IDU 12 is shown in a high level block diagram in accordance with the invention. The IDU 12 comprises status receive circuitry 101 to receive and decode the telemetry data sent from the ODU 14, control transmit circuitry 102 to send commands to the ODU 14 (which is used when implementing a bi-directional telemetry link), an IDU controller 428 to interpret telemetry status data received from the ODU 14 and to generate commands to be sent via the control transmit circuitry to the ODU 14, and multiplexer 100 to combine the signals onto the IFL 16. The digital capture logic used in the status receive circuitry 101 and the control receive circuitry 102 (see FIG. 5 and FIG. 7) utilizes a clock that operates at a much higher rate than the symbol rate to process the input signal (approximately 10 times the symbol rate).

Referring to FIG. 7, the front end of the status receive circuitry 101 looks much like the front end of the control receive circuitry, with a bandpass filter 428, an envelope detector 429, an analog lowpass filter 430 and a comparator 431. The comparator 431 has a threshold circuit 416 that in a specific embodiment uses an automatically calibrated threshold unit to track the Manchester encoded input. (This can be a simple RC circuit.) The first block in the digital capture logic 418 of the status receive circuitry 101 is a (digital-type) low pass filter (LPF) 427. In this case, the LPF 427 is a simple majority vote over five samples. The preamble detect module 434 determines packet synchronization. The preamble detect detects a 1-symbol duration “0” followed by a 2-symbol duration “1”. Note: Because the preamble detect continuously runs, the ODU reference can be fairly coarse (10×5 accuracy). The preamble detect is designed to account for transfer and filtering distortions. Once packet synchronization is achieved, the logic will capture the input data. The input signal is sampled at a much higher rate than the input symbol timing. Therefore, once packet synchronization has been achieved it is easy to determine the center of each bit.

FIG. 13 shows the IDU timing diagram. To account for timing errors and waveform distortion only the center portion of each bit half is to be used to determine bit value during any sampling period. That is, the center samples of the first half of the bit time is subtracted from the center samples of the second half of the bit time. The sign bit of the resultant value determines the receive bit value (0 or 1). The next step is to accumulate multiple N-bit values. This accumulation is performed by the integrate and dump function of integrate and dump module 436. The accumulate/dump process starts accumulation at the “Start CMD” or Start Command issued by the telemetry state machine 433 and integrates (adds) until the “End CMD” is received. Only input packets that exceed the programmed signal threshold and that are identified as output power data are accumulated. When the “End CMD” is received, the accumulated value is divided by the number of N-bit inputs accumulated. The averaged value is then placed into an output buffer (not shown) for post processing. FIG. 5 and FIG. 7 each illustrate suitable digital capture logic 318 and 418. The actual start and end commands are design specific, and so details thereof are subject to engineering choice as determined by each system designer.

The example telemetry link is designed for bi-directional communication with two exemplary methods in mind. In method B, special circuitry in the ODU 14 and in the IDU 12 is used to schedule packets sent and received from the IDU 12 (see FIG. 2, ODU Control and FIG. 6 IDU Controller). Data packets are sent and received in a synchronous format so that collision of the data packets does not occur. In method B, data packets are sent initially from the ODU 14 to the IDU 12 at power up. The IDU 12 must first obtain data packet synchronization with the incoming ODU telemetry packets before it can send telemetry packets to the ODU 14. The IDU 12 is programmed to align the outbound packets to start at the middle of the stop symbol of the incoming packet generated by the ODU 14. The ODU 14 is programmed to be required to detect the incoming packet and not start transmission of the outgoing packet until the middle of the incoming packet's stop bit time. This is necessary only in the case of a bi-directional link where the IDU 12 sends commands for the ODU 14 to perform using the same carrier frequency as used to send data from the ODU 14 to the IDU 12.

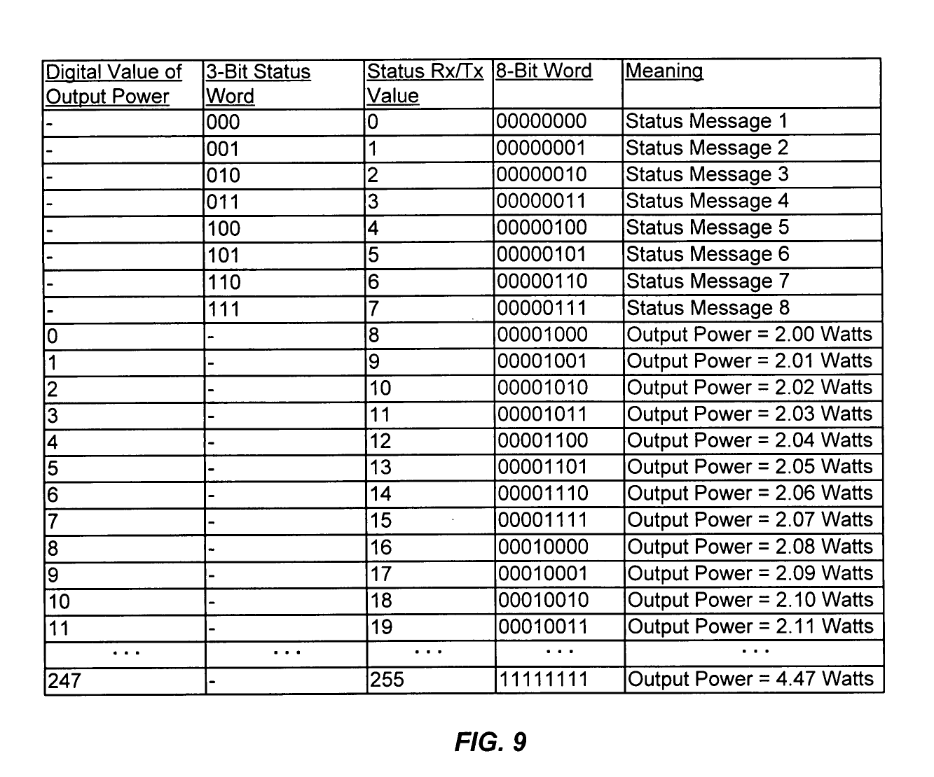

Referring to FIG. 9, an example of data packet scheduling is shown in accordance with the invention. In this case an 8 bit word is used, and the lowest 8 values for 8 different status values are reserved. The upper 247 codes are reserved for power readings. The IDU 12 can use a table like this to interpret the difference between a power reading and a status message. Another way to achieve this bi-directional telemetry link is with a full-duplex connection as in method B. In this method more bandwidth is allocated for the IDU to ODU communication and the transmit and receive occur at different frequencies. An example is to use 85 MHz as the carrier frequency for sending data from the ODU 14 to the IDU 12 and to use 2 Hz as the carrier frequency for sending data from the IDU 12 to the ODU 14. This extreme separation means that both signals are simultaneously dealt with in the multiplexer.

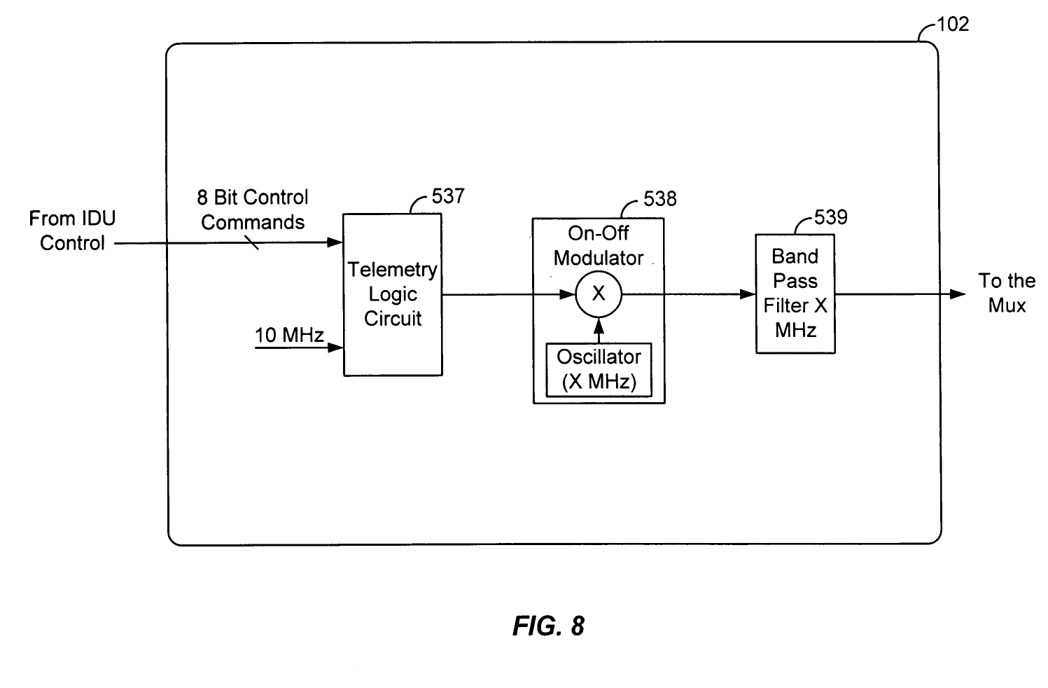

FIG. 8 shows an example of a control transmit circuit 102 in accordance with the invention. Its similarity to the elements in the status transmit circuitry 103 are evident. This circuit has the following: telemetry logic circuit 537, which accepts 8-bit commands from the IDU Control and outputs Manchester Encoded Packets; an on-off modulator 538, which accepts the packets and in turn pulse width modulates them in accordance with the selected local oscillator frequency and method; a bandpass filter 539 centered at the selected local oscillator frequency to eliminate noise.

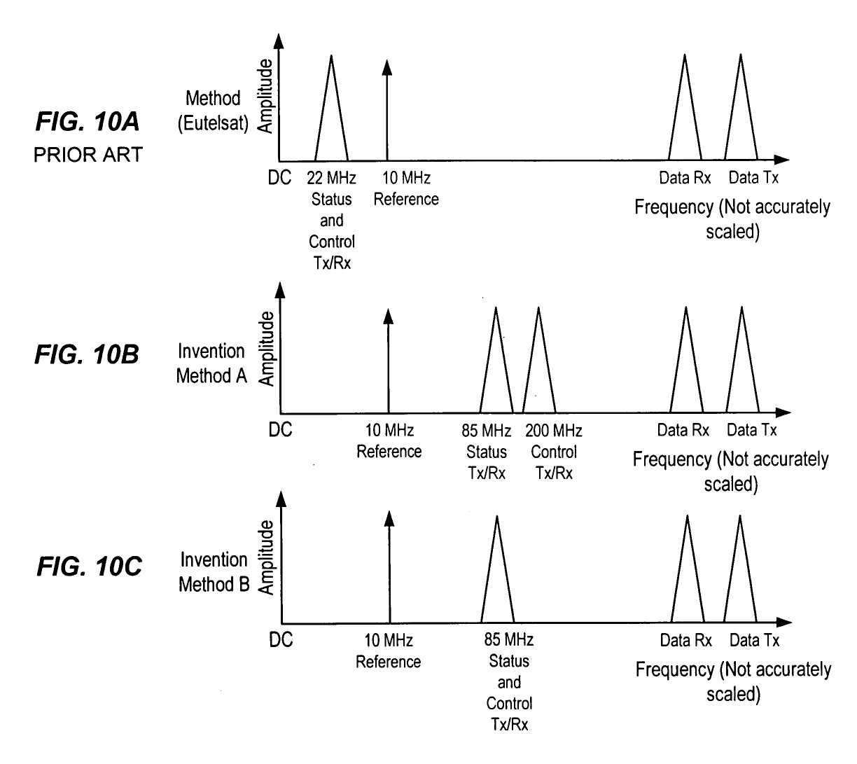

FIGS. 10A, B and C illustrate graphically how in the frequency domain the present invention (according to methods A and B) differ from the existing Eutelsat method. Whereas in Eutelsat, a status and control band is centered at 22 kHz, here status and control are either in a pair of bands at 80 MHz and 200 MHz or in a single 85 MHz band.

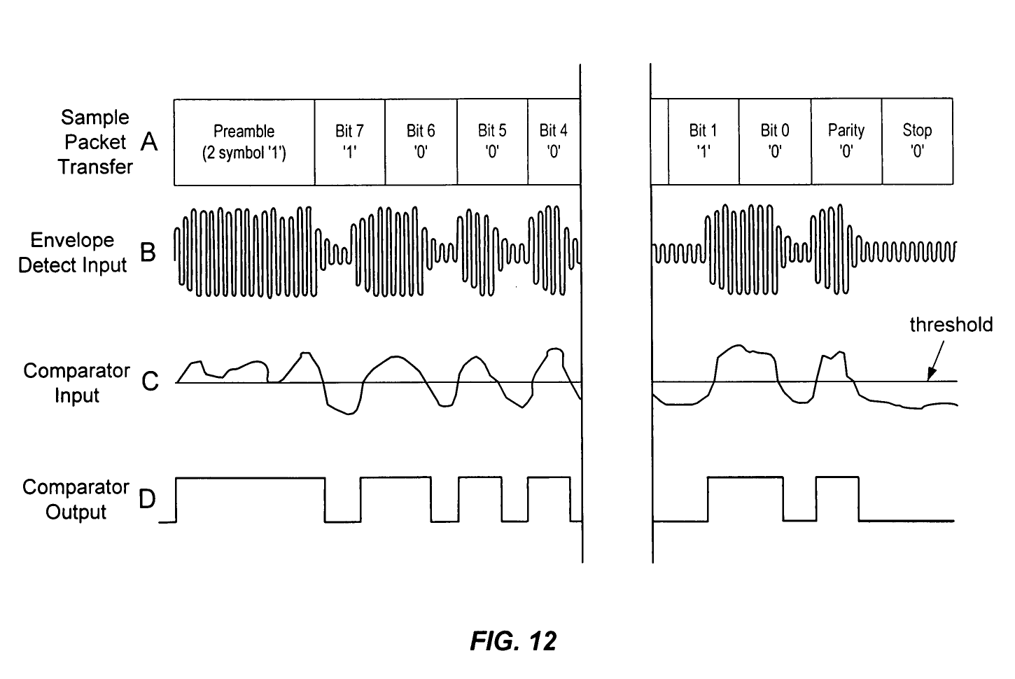

FIG. 12 shows how the envelope detector and comparator in the IDU 12 serve to demodulate the data received from the ODU 14. The sample packet stream (Line A) produces envelope detected input (Line B) with a comparator input (Line C) to yield comparator output (Line D).

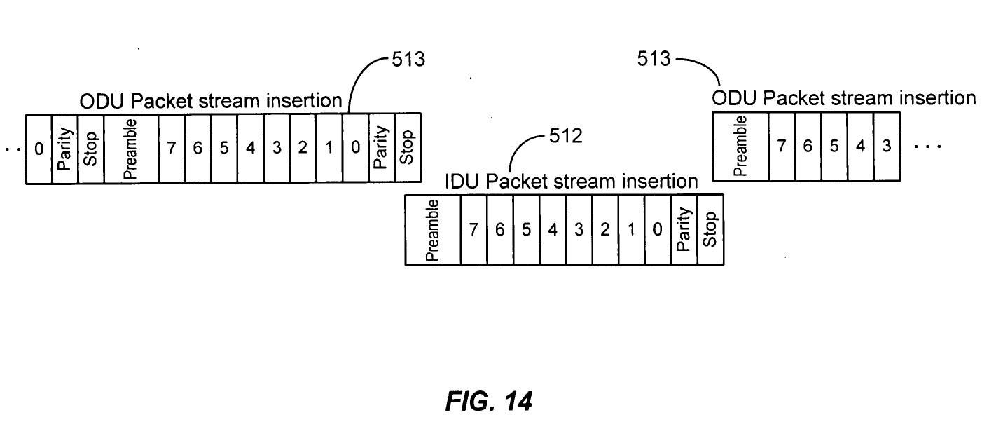

FIG. 14 shows a possible way to organize packets so that a bi-directional telemetry link can be established between the IDU 12 and ODU 14. In this case, both packets could be modulated with the same carrier frequency and multiplexed in time alternating between an ODU packet stream 550 interrupted by insertion of an IDU packet stream 552.

The invention has been explained with reference to specific embodiments. Other embodiments will be evident to those of ordinary skill in the art. It is therefore not intended that this invention be limited, except as indicated by the appended claims.

What is claimed is:

1. A method for communicating on a single broadband cable between an indoor unit and an outdoor unit of a satellite earth terminal comprising:
a. Manchester encoding a control signal at said indoor unit to obtain a Manchester encoded control signal;
b. on-off modulating said Manchester encoded control signal at said indoor unit to obtain a modulated control signal;
c. multiplexing said modulated control signal at said indoor unit to obtain a multiplexed control signal;
d. conveying said multiplexed control signal from said indoor unit to said outdoor unit via said single broadband cable;
e. demultiplexing said multiplexed control signal at said outdoor unit to obtain a demultiplexed control signal; and
f. demodulating said demultiplexed control signal using envelope detection followed by threshold comparison at said outdoor unit.

2. The method of claim 1 wherein said threshold comparision uses an automatically calibrated threshold value.

3. The method of claim 1 wherein said demodulation step is followed by a preamble detecting step.

4. The method of claim 3 wherein said preamble detecting step is followed by a packet capturing step.

5. The method of claim 4 wherein said packet capturing step is followed by an integrating and dumping step.

6. A method for communicating on a single broadband cable between an outdoor unit and an indoor unit of a satellite earth terminal comprising:
a. Manchester encoding a status signal at said outdoor unit to obtain a Manchester encoded status signal;
b. on-off modulating said Manchester encoded status signal at said outdoor unit to obtain a modulated status signal;
c. multiplexing said modulated status signal at said outdoor unit to obtain a multiplexed status signal;
d. conveying said multiplexed status signal from said outdoor unit to said indoor unit via said single broadband cable;
e. demultiplexing said multiplexed status signal at said indoor unit to obtain a demultiplexed status signal; and
f. demodulating said demultiplexed status signal using envelope detection followed by threshold comparison at said indoor unit.

7. The method of claim 6 wherein said threshold comparision uses an automatically calibrated threshold value.

8. The method of claim 6 wherein said demodulation step is followed by a preamble detecting step.

9. The method of claim 8 wherein said preamble detecting step is followed by a packet capturing step.

10. The method of claim 9 wherein said packet capturing step is followed by an integrating and dumping step.

11. An apparatus for bi-directional communication on a single broadband cable between an indoor unit and an outdoor unit of a satellite earth terminal comprising:
a. a first Manchester encoder for encoding a control signal at said indoor unit to obtain a Manchester encoded control signal;
b. a first on-off modulator for modulating said Manchester encoded control signal at said indoor unit to obtain a modulated control signal;
c. a first multiplexer for multiplexing said modulated control signal onto said single broadband cable at said indoor unit to obtain a multiplexed modulated control signal;
d. an interfacility link including said single broadband cable between said indoor unit and said outdoor unit for conveying said multiplexed modulated control signal from said indoor unit to said outdoor unit;
e. a first demultiplexer for demultiplexing said multiplexed modulated control signal at said outdoor unit to obtain a demultiplexed control signal;
h. a first demodulator for demodulating said demultiplexed status signal using envelope detector followed by threshold comparator at said indoor unit;
i. a second Manchester encoder for Manchester encoding a status signal at said outdoor unit to obtain a Manchester encoded status signal;
j. a second on-off modulator for on-off modulating said Manchester encoded status signal at said outdoor unit to obtain a modulated status signal;
k. a second multiplexer for multiplexing said modulated status signal at said outdoor unit to obtain a multiplexed status signal to be conveyed via said interfacility link in a non interfering manner with said multiplexed control signal;
l. a second demultiplexer for demultiplexing said multiplexed status signal at said indoor unit to obtain a demultiplexed status signal; and
m. a second demodulator for demodulating said demultiplexed status signal using an envelope detector followed by a threshold comparator at said indoor unit.

12. The apparatus of claim 11 wherein at least one of said first and second threshold comparators uses an automatically calibrated threshold value.

13. The apparatus of claim 11 wherein at least one of said first and second demodulators is followed by a preamble detector.

14. The apparatus of claim 13 wherein at least one of said preamble detectors is followed by a packet capturing unit.

15. The apparatus of claim 14 wherein at least one of said packet capturing units is followed by an integrator and dumping unit.
